(19) United States
(12) Patent Application Publication
(10) Pub. No.: US 2006/0193323 A1
(43) Pub. Date: Aug. 31, 2006

(54) Apparatus and method for providing session initiation protocol (SIP) service in private network

(76) Inventor: Dae-Hyun Lee, Suwon-si (KR)

Correspondence Address: Robert E. Bushnell;Suite 300, 1522 K Street, N.W., Washington, DC, 20005-1202, US

(21) Appl. No.: 11/330,231

(22) Filed: Jan. 12, 2006

(30) Foreign Application Priority Data
Feb. 28, 2005 (KR) 2005-16733

(51) Int. Cl. H04L 12/56

(52) U.S. Cl. 370/392; 370/401

(57) ABSTRACT

An apparatus for providing a session initiation protocol (SIP) service comprises: a gateway installed in a boundary between a private network and a public network, the gateway detecting identifier information and address information of SIP terminals located in the private network using an SIP message transmitted between the private network and the public network; and a storage device for storing a mapping table which manages the identifier information and the address information. A corresponding method comprises the steps of: receiving, by means of the gateway, an SIP message to be transmitted from an SIP terminal in the private network to the public network; determining, from the SIP message, identifier information and address information of the SIP terminal; registering the identifier information and address information of the SIP terminal in a mapping table; receiving, by means of the gateway, an SIP message inputted from the public network; determining, from the SIP message, identifier information of an SIP terminal to which the SIP message is to be transmitted; determining, from the mapping table, address information corresponding to the identifier information determined in the previous step; and transmitting the SIP message inputted from the public network using the determined address information.

### CLAIM OF PRIORITY

This application makes reference to, incorporates the same herein, and claims all benefits accruing under 35 U.S.C. §119 from an application for APPARATUS AND METHOD FOR PROVIDING SIP SERVICE IN PRIVATE NETWORK earlier filed in the Korean Intellectual Property Office on Feb. 28, 2005 and there duly assigned Serial No. 2005-16733.

### BACKGROUND OF THE INVENTION

1. Technical Field

The present invention relates to an apparatus and method for providing a session initiation protocol (SIP) service and, more particularly, to an apparatus and method for providing an SIP service in a private network using, for example, network address translation (NAT).

2. Related Art

According to the SIP standard, a destination port is designated as a well-known port (e.g., a 5060 port). Thus, if a plurality of SIP terminals exist in a private network, it is impossible to identify an SIP terminal using only a destination port. For example, in a VoIP network using an SIP, if an SIP phone exists in a private network, access from external portions is restricted to only a 5060 port, and thus if a plurality of SIP phones exist in the private network, it is impossible to identify the SIP phone.

In order to resolve the above problem, an SIP server for managing the SIP phones has been introduced. The SIP server stores identifiers and IP addresses of the SIP phones in the private network, and identifies the SIP phones in the private network using this information.

An SIP service providing system includes a plurality of SIP phones which exist in the private network and an SIP server which manages address information of each of the SIP phones. In that regard, the SIP server stores identifiers (e.g., SIP phone IDs) of the respective SIP phones and corresponding IP addresses in the private network.

If an SIP message is transferred to an SIP port (e.g., a 5060 port), the SIP message is transmitted to the SIP server. The SIP server reads a “To” field of the SIP message to determine an identifier of the SIP phone to which the SIP message is to be transmitted, and detects an IP address corresponding to the identifier of that SIP phone so as to transmit the SIP message to the detected IP address.

The method described above has a disadvantage in that a plurality of SIP proxy servers must be run if the method is applied to a zone using a plurality of private networks. Moreover, the SIP message must pass through the plurality of SIP proxy servers before being transmitted, which causes unnecessary delay during the call setup operation.

### SUMMARY OF THE INVENTION

It is, therefore, an object of the present invention to provide an apparatus and method for providing an SIP service in which only a single SIP proxy server can be run, even in a zone using a plurality of private networks.

It is another object to provide an apparatus and method for providing an SIP service in which unnecessary delay during call setup operation is reduced.

It is yet another object to provide an apparatus and method for efficiently providing an SIP service in a private network.

According to an aspect of the invention for realizing the above objects, there is provided an apparatus which comprises: a gateway installed in a boundary between a private network and a public network, the gateway detecting identifier information and address information of SIP terminals located in the private network using an SIP message transmitted between the private network and the public network; and a storage device for storing a mapping table which manages the identifier information and the address information.

Preferably, the gateway detects, from a REGISTER message, the identifier information and the address information of an SIP terminal which transmits the REGISTER message from the private network to the public network, and registers the identifier information and address information in the mapping table. The gateway detects, from an INVITE message, identifier information of an SIP terminal to which the INVITE message inputted from the public network to the private network is to be transmitted, and retrieves the mapping table so as to read address information corresponding to the identifier information of the SIP terminal.

Preferably, the gateway is a session initiation protocol application layer gateway (SIP ALG). Preferably, the mapping table stores valid time information of each entry, and deletes an entry when a corresponding message is not transmitted during the valid time.

According to another aspect of the invention for realizing the above objects, a method for providing an SIP service using an application layer gateway installed in a boundary between a private network and a public network comprises the steps of: (a) receiving, by means of the gateway, an SIP message to be transmitted from an SIP terminal in the private network to the public network; (b) detecting identifier information and address information of the SIP terminal from the SIP message; (c) registering the identifier information and address information of the SIP terminal in a mapping table; (d) receiving, by means of the gateway, an SIP message inputted from the public network; (e) detecting, from the SIP message, identifier information of an SIP terminal to which the SIP message is to be transmitted; (f) detecting, from the mapping table, address information corresponding to the detected identifier information of the SIP terminal; and (g) transmitting the SIP message inputted from the public network using the detected address information of the SIP terminal.

Preferably, in step (d), a REGISTER message is received from the SIP terminal, and identifier information and address information of the SIP terminal which transmitted the REGISTER message are detected based on source address information of the REGISTER message and source information (a “From” field) contained in the REGISTER message.

Preferably, in step (a), an INVITE message inputted from the public network is received, and in step (e), identifier information of an SIP terminal to which the INVITE message is to be transmitted is detected based on destination information (a “To” field) contained in the INVITE message.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic view of a system for providing SIP service in a private network;

FIG. 2 is a schematic view of a system for providing SIP service in a private network according to the present invention;

FIG. 3 is a flowchart illustrating a method of providing SIP service in a private network according to the present invention;

FIG. 4 is a diagram illustrating the format of a REGISTER message according to the present invention;

FIG. 5 is a diagram of a mapping table according to the present invention;

FIG. 6 is a diagram illustrating the format of an INVITE message according to the present invention;

FIG. 7 is a diagram illustrating a process for producing the mapping table so as to provide the SIP service in the private network according to the present invention; and

FIG. 8 is a diagram illustrating a process for referring to the mapping table so as to provide the SIP service in the private network according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

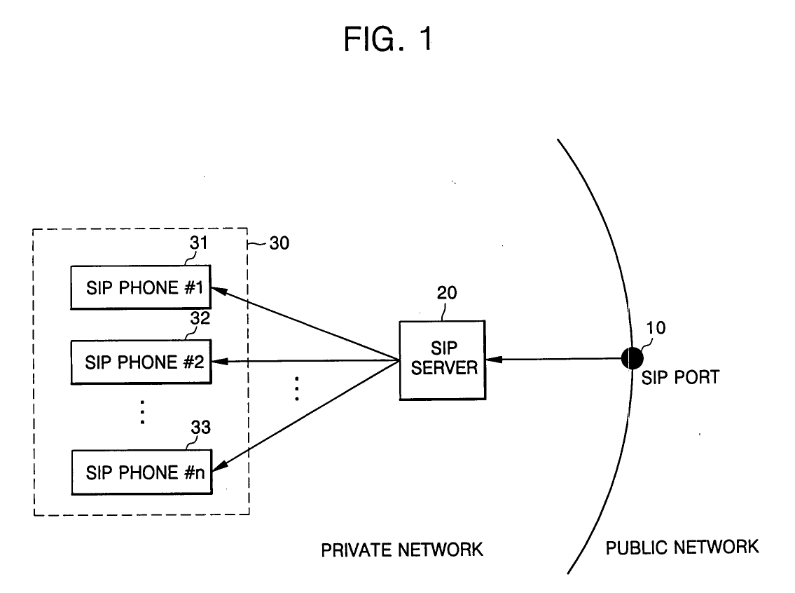

FIG. 1 is a schematic view of a system for providing SIP service in a private network. As shown in FIG. 1, the SIP service providing system includes a plurality of SIP phones 30 (for example, SIP phones 31 to 33) which exist in the private network, and an SIP server 20 which manages address information of each of the SIP phones 31 to 33. The SIP server 20 stores identifiers (e.g., SIP phone IDs) of the respective SIP phones 30 and corresponding IP addresses in the private network.

If an SIP message is transferred to an SIP port 10 (e.g., a 5060 port), the SIP message is transmitted to the SIP server 20. The SIP server 20 reads a “To” field of the SIP message to determine an identifier of the SIP phone to which the SIP message is to be transmitted, and detects an IP address corresponding to the determined identifier so as to transmit the SIP message to that IP address.

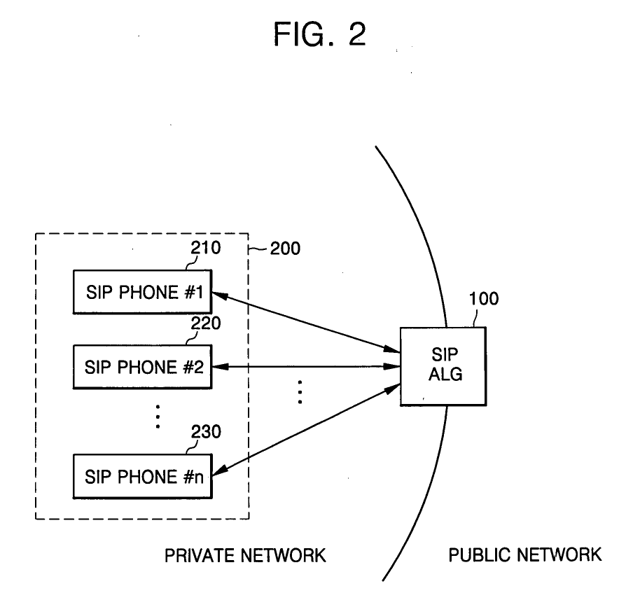

FIG. 2 is a schematic view of a system for providing SIP service in a private network according to the present invention. As shown in FIG. 2, the SIP service providing system includes an SIP application layer gateway (ALG) 100 which manages address information of each of a plurality of SIP phones 200 (for example, SIP phones 210, 220 and 230) which exist in the private network. The SIP ALG 100 is installed in a boundary region between a private network and a public network.

The SIP ALG 100 provides call service and voice service for a call session from the private network to an external portion (e.g., a public network). However, the SIP ALG 100 supports only restricted access connection to the private network from an external portion (e.g., a public network).

However, the SIP ALG 100 of FIG. 2 is designed to flexibly process a call session from the public network to the private network, as well as a call session from the private network to the public network.

To enable this function, the SIP ALG 100 produces a mapping table which is used to manage IP address information of the SIP phones 210, 220 and 230 using an SIP message (e.g., a register message) transmitted from the private network to the public network, and transmits a corresponding SIP message to a corresponding SIP phone in the private network using the mapping table when the SIP message is received from the public network.

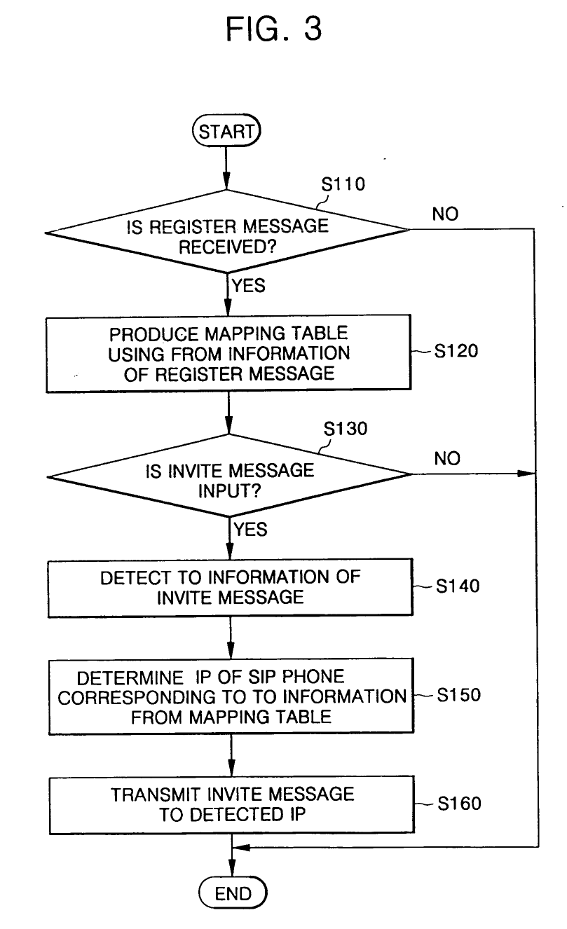

FIG. 3 is a flowchart illustrating a method of providing SIP service in a private network according to the present invention. FIG. 3 shows processes or steps performed by the SIP ALG 100 in order to produce the mapping table, and in order to transmit the SIP message to the SIP phone using the mapping table.

Referring to FIGS. 2 and 3, when the SIP ALG 100 receives a REGISTER message from an SIP phone in the private network (S110), the SIP ALG 100 produces a mapping table using “From” information contained in the REGISTER message (S120). In this regard, the REGISTER message is an SIP message transmitted by the SIP phone desiring SIP service in order to register with the SIP ALG 100.

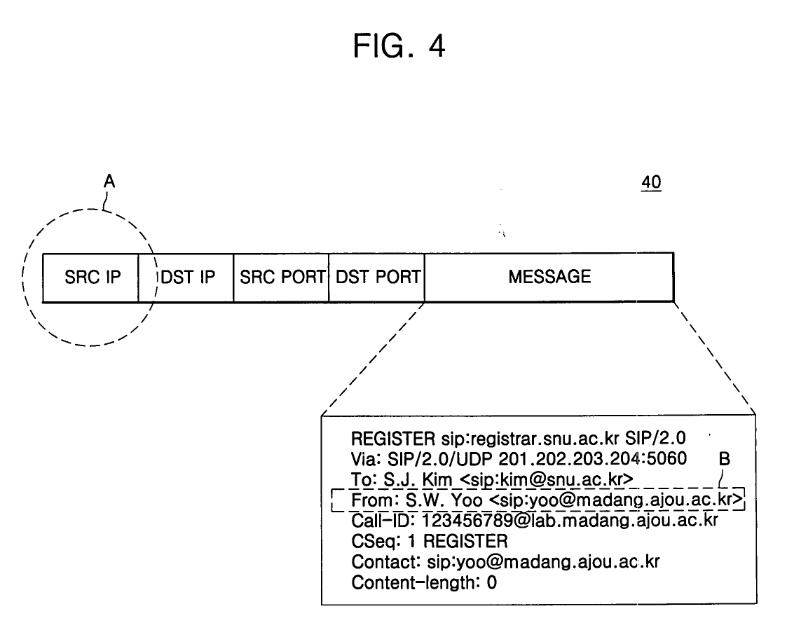

An example of the format of the REGISTER message is shown in FIG. 4, which is a diagram illustrating the format of a REGISTER message according to the present invention. Referring to FIG. 4, the REGISTER message 40 contains a source IP address SRC IP, a destination IP address DST IP, a source port SRC PORT, a destination port DST PORT, and a MESSAGE field or region. The MESSAGE field or region contains network information used to transmit the message. In particular, the MESSAGE field or region contains an identifier of the SIP phone which has transmitted the message (“From: S. W. Yoo <sip:yoo@madang.ajou.ac.kr>”), and an identifier of the SIP phone to which the message is to be transmitted (“To: S. J. Kim <sip:kim@snu.ac.kr>”).

In step S120 of FIG. 3, the mapping table is configured using the source IP address A of the source which has transmitted the message, and the identifier B of the SIP phone which has transmitted the message (i.e., “From” information).

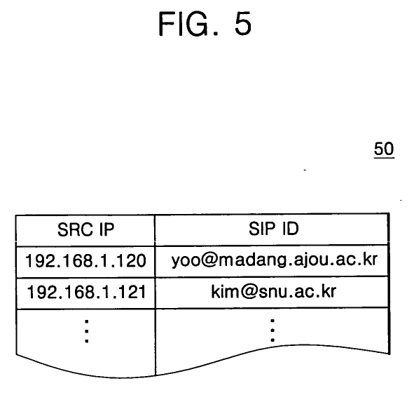

The produced mapping table is shown in FIG. 5, which is a diagram of a mapping table according to the present invention. Referring to FIG. 5, presuming that two or more SIP phones exist in the private network, an IP address of the first SIP phone in the private network is “192.168.1.120”, and the identifier ID of the first SIP phone is yoo@madang.ajou.ac.kr, while an IP address of the second SIP phone in the private network is “192.168.1.121”, and the identifier ID of the second SIP phone is kim@snu.ac.kr. Preferably, valid time information is added to each entry, and if the message is transmitted during the valid time period, a corresponding entry is deleted.

Referring back to FIGS. 2 and 3, when the mapping table of FIG. 5 is configured in step S120, the SIP ALG 100 waits for an INVITE message from an external portion (e.g., a public network).

When the INVITE message is inputted (S130), the SIP ALG 100 analyzes the INVITE message to detect “To” information (S140). That is, it determines the portion (e.g., the SIP phone) in the private network to which the INVITE message is to be transmitted.

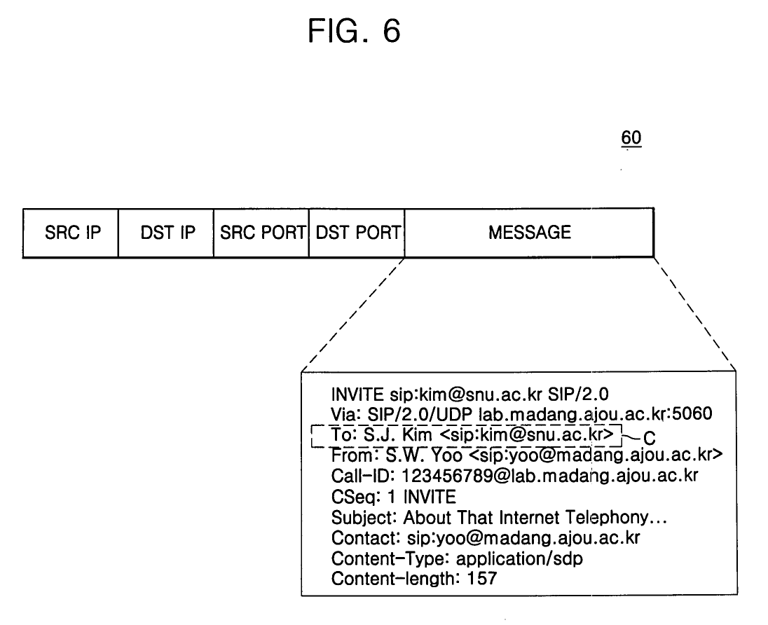

FIG. 6 is a diagram illustrating the format of an INVITE message according to the present invention. Referring to FIG. 6, the INVITE message 60 contains a source IP address SRC IP, a destination IP address DST IP, a source port SRC PORT, a destination port DST PORT, and a MESSAGE region. The MESSAGE region contains network information used to transmit the message. In particular, the MESSAGE region contains an identifier of the SIP phone which has transmitted the message (“From: S. W. Yoo <sip:yoo@madang.ajou.ac.kr>”), and an identifier of the SIP phone to which the message is to be transmitted (“To: S. J. Kim <sip:kim@snu.ac.kr>”). The INVITE message 60 has a configuration similar to the configuration of the REGISTER message of FIG. 4. Only the content of a “Cseq” region or field (e.g., information to identify the message) is different. That is, the “Cseq” region or field of the REGISTER message contains “REGISTER”, while the “Cseq” region or field of the INVITE message contains “INVITE”.

In step S140, the identifier C (i.e., “To” information) of the SIP phone to which the INVITE message 60 of FIG. 6 is to be transmitted is detected from the INVITE message 60 of FIG. 6.

Then, an IP address of the SIP phone corresponding to “To” information detected in step S140 is determined from the mapping table of FIG. 5 (S150). Referring to FIGS. 5 and 6, the To information detected in step S140 is “To: S. J. Kim <sip: kim@snu.ac.kr>”, and the IP address of the corresponding SIP phone as determined in steps S150 is “192.168.1.121”.

Finally, in step S160, the SIP ALG 100 transmits the INVITE message to the IP address determined in step S150.

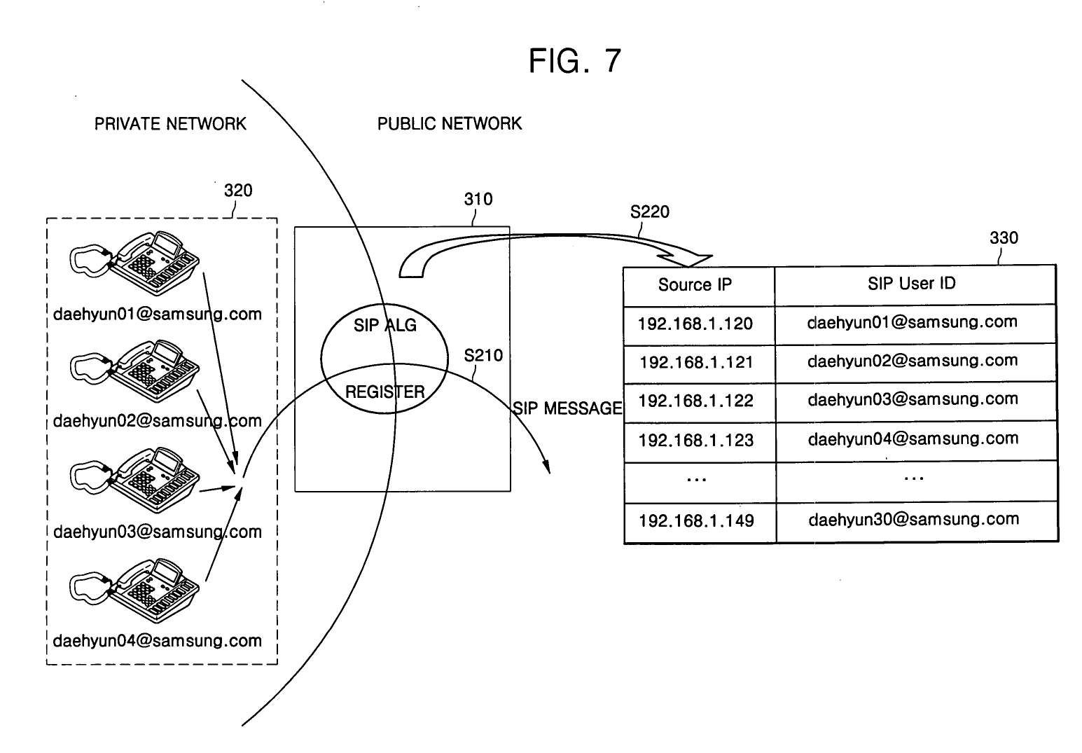

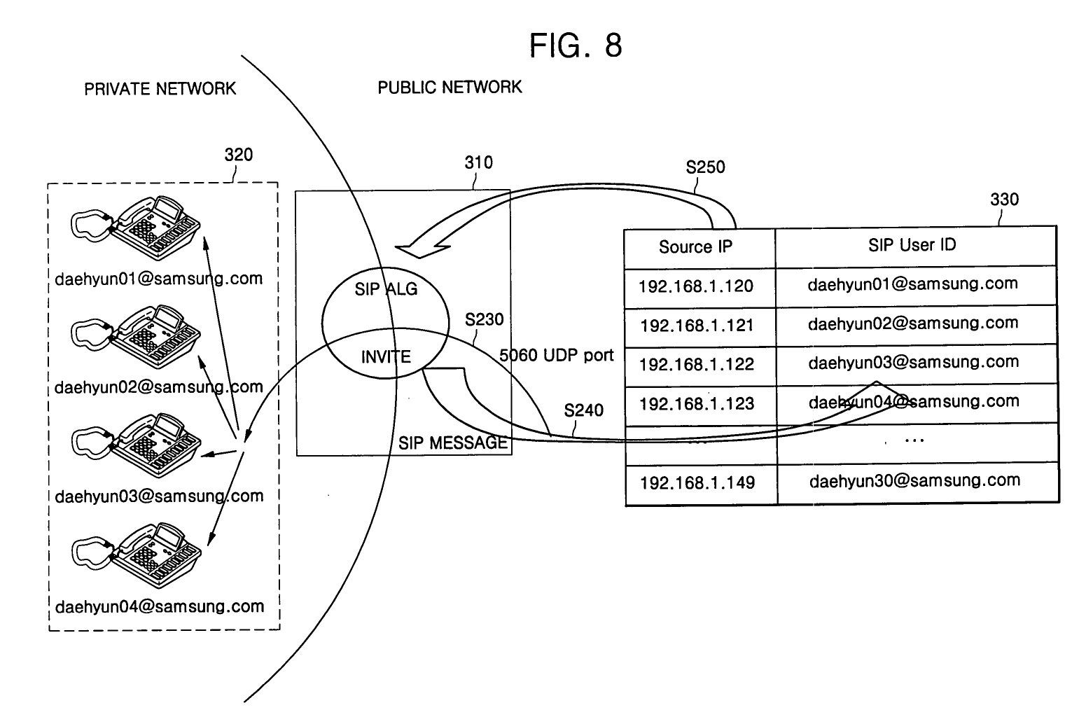

FIGS. 7 and 8 are schematic diagrams illustrating the method of providing the SIP service according to the present invention. More specifically, FIG. 7 is a diagram illustrating a process for producing the mapping table so as to provide the SIP service in the private network according to the present invention, and FIG. 8 is a diagram illustrating a process for referring to the mapping table to provide the SIP service in the private network according to the present invention.

Referring to FIG. 7, when a plurality of SIP phones 320 attempt to transmit a message to an external portion (e.g., public network) through the SIP ALG 310, the SIP phones 320 register their IP addresses and SIP phone IDs in the mapping table 330 in the SIP ALG 310 using the SIP message (REGISTER). That is, if any of the SIP phones 320 transmits the SIP message (REGISTER) to the SIP ALG 310 (S210), the SIP ALG 310 detects the IP address and SIP phone ID of the corresponding SIP phone, and then registers them in the mapping table 330 (S220).

FIG. 7 shows an example in which 30 SIP phones in the private network have registered their IP addresses (192.168.1.120 thru 192.168.1.149) and SIP phone IDs in the mapping table 330.

Referring to FIG. 8, when a user of an SIP phone located outside the private network (e.g., in a public network) transmits the SIP message (INVITE) to the SIP ALG 310 so as to transmit a message to a certain SIP phone located in the private network, the SIP ALG 310 determines the destination IP address of the SIP message from the mapping table 330 shown in FIG. 8. That is, if the SIP ALG 310 receives the SIP message (INVITE) (S230), the SIP ALG 310 detects To information (i.e., an identifier of the destination SIP phone) of the SIP message (INVITE), and then retrieves information from the mapping table 330 using the “To” information (S240). The SIP ALG 310 also determines an IP address corresponding to the “To” information from the mapping table 330 (S250).

A preferred embodiment of the present invention has been described above, but the present invention may be modified in various forms. For example, while the above-described embodiment involves SIP phones using the VoIP system, the present invention is not limited to SIP phones and the VoIP system. The present invention relates to an apparatus and method for identifying a plurality of terminals connected to a fixed port, and providing one of a plurality of terminals connected to the port with packet data inputted through the port. Thus, the scope of the present invention is not limited to the embodiment described herein, but rather is defined by the appended claims and their equivalents.

As described above, the present invention runs only one SIP proxy server in a zone using a plurality of private networks, so that an SIP message is transmitted after passing through the one SIP proxy server. Thus, unnecessary delay which may occur during the call setup operation can be reduced, thereby enabling more efficient SIP service in the private network.

Although the preferred embodiments of the present invention have been described in detail, it will be appreciated by those skilled in the art to which the present invention pertains that several modifications and variations can be made without departing from the spirit and scope of the present invention as defined in the appended claims. Accordingly, future variations of the embodiments of the present invention can be covered by the technique of the present invention.

What is claimed is:

1. An apparatus for providing a session initiation protocol (SIP) service, comprising:
a gateway installed in a boundary between a private network and a public network, the gateway determining identifier information and address information of SIP terminals located in the private network using an SIP message transmitted between the private network and the public network; and
storage means for storing a mapping table which manages the identifier information and the address information.

2. The apparatus of claim 1, wherein the gateway determines, from the SIP message, the identifier information and the address information of an SIP terminal which transmits the SIP message between the private network and the public network, and registers the identifier information and the address information in the mapping table.

3. The apparatus of claim 2, wherein the gateway determines the address information of the SIP terminal with reference to contents of a source IP address field contained in a REGISTER message transmitted between the private network and the public network, and determines the identifier information of the SIP terminal with reference to a source information field contained in the REGISTER message.

4. The apparatus of claim 3, wherein the address information of the SIP terminal is an address of the SIP terminal in the private network.

5. The apparatus of claim 1, wherein the gateway determines, from the SIP message, identifier information of an SIP terminal to which an SIP message inputted from the public network to the private network is to be transmitted, and retrieves the mapping table to read address information corresponding to the identifier information of the SIP terminal to which the SIP message inputted from the public network is to be transmitted.

6. The apparatus of claim 5, wherein the gateway determines the address information of an SIP terminal to which an INVITE message inputted from the public network to the private network is to be transmitted with reference to destination information contained in a message field of the INVITE message.

7. The apparatus of claim 6, wherein the gateway comprises a session initiation protocol application layer gateway (SIP ALG).

8. The apparatus of claim 1, wherein the address information managed by the mapping table stored in the storage means comprises corresponding IP addresses of the SIP terminals located in the private network.

9. The apparatus of claim 8, wherein information as to a valid time is added to each entry of the mapping table, and a corresponding entry is deleted when a message is not transmitted during the valid time.

10. A method of providing a session initiation protocol (SIP) service using an application layer gateway installed in a boundary between a private network and a public network, the method comprising the steps of:
(a) receiving, by means of the gateway, an SIP message to be transmitted from an SIP terminal in the private network to the public network;
(b) determining, from the SIP message, identifier information and address information of the SIP terminal;
(c) registering, in a mapping table, the identifier information and the address information of the SIP terminal;
(d) receiving, by means of the gateway, an SIP message inputted from the public network;
(e) determining, from the SIP message, identifier information of an SIP terminal to which the SIP message is to be transmitted;
(f) determining, from the mapping table, address information corresponding to the identifier information of the SIP terminal determined in step (e); and
(g) transmitting the SIP message inputted from the public network using the address information determined in step (f).

11. The method of claim 10, wherein, in step (a), a REGISTER message is received from the SIP terminal, and in step (b), identifier information and address information of the SIP terminal which transmitted the REGISTER message are determined based on source address information of the REGISTER message and source information contained in a message field of the REGISTER message.

12. The method of claim 10, wherein in step (d), an INVITE message inputted from the public network is received, and in step (e), identifier information of an SIP terminal to which the INVITE message is to be transmitted is detected based on destination information contained in the INVITE message.
